(19) United States
(12) Patent Application Publication
(10) Pub. No.: US 2026/0257207 A1
(43) Pub. Date: Sep. 3, 2026

(54) COBALT-BASED CATALYST FOR THE CONVERSION OF HYDROCARBONS TO SYNTHESIS GAS

(71) Applicant: BASF SE, Ludwigshafen am Rhein (DE)

(72) Inventors: Hamideh AHI, Ludwigshafen am Rhein (DE); Stefan DIETRICH, Ludwigshafen am Rhein (DE); Manuel Frederik GENTZEN, Ludwigshafen am Rhein (DE); Michael KRAEMER, Ludwigshafen am Rhein (DE); Nils BOTTKE, Ludwigshafen am Rhein (DE); Stephan A. SCHUNK, Heidelberg (DE); Virginie LANVER, Ludwigshafen am Rhein (DE); Sandra MAGNUS, Ludwigshafen am Rhein (DE)

(21) Appl. No.: 18/879,839

(22) PCT Filed: Jun. 30, 2023
(86) PCT No.: PCT/EP2023/068006

§ 371 Date: Dec. 30, 2024

(30) Foreign Application Priority Data
Jul. 1, 2022 (EP) 22182593.8

(51) Int. Cl. B01J 23/83; B01J 6/00; B01J 37/00; B01J 37/04; B01J 37/08; C01B 3/26

(52) U.S. Cl. CPC B01J 23/83; B01J 6/001; B01J 37/0063; B01J 37/04; B01J 37/08; C01B 3/26; C01B 2203/1052

(57) ABSTRACT

The present invention relates to a composite oxide comprising oxygen, lanthanum, aluminum, and cobalt, wherein the Co:La weight ratio of cobalt relative to lanthanum in the composite oxide, calculated as the elements, is in the range of from 0.06:1 to 0.34:1, as well as to a method for its production. Furthermore, the present invention relates to a method for the production of a catalyst for the conversion of hydrocarbons to synthesis gas, as well as to a catalyst as obtainable or obtained according to said method, and to a process for the conversion of hydrocarbons to synthesis gas.

### TECHNICAL FIELD

The present invention relates to a composite oxide comprising oxygen, lanthanum, aluminum, and cobalt, wherein the composite oxide has a specific Co:La weight ratio. Further, the present invention relates to a method for the production of a composite oxide and a composite oxide obtainable or obtained by said method. Yet further, the present invention relates to a method for the production of a catalyst for the conversion of hydrocarbons to synthesis gas, and a catalyst obtainable or obtained by said method. Yet further, the present invention relates to a process for the conversion of hydrocarbons to synthesis gas.

### DETAILED DESCRIPTION

Ni- or Co-containing oxide-based catalysts are commonly used for the reforming of hydrocarbons to synthesis gas. Applying Co-containing catalysts lowers the production cost since they allow a lower content of steam in the feed. However, difficulties in the activation of the Co-containing catalysts due to a special activation procedure which is required regularly leads to an increase in production costs.

WO 2013/118078 A1 relates to a Ni- or Co-containing hexaaluminate catalyst for the reforming of hydrocarbons. WO 2014/135642 A1 concerns a Ni-containing hexaaluminate catalyst for the reforming of hydrocarbons in the presence of CO₂. Similarly, WO 2015/091310 A1 concerns a method for reforming mixtures of hydrocarbons and CO₂. US 2016/0207031 A1 and U.S. Pat. No. 9,566,571 B2 specifically concern a process for producing a catalyst for the reforming of hydrocarbons from a feed gas comprising methane and CO₂.

WO 2014/001423 A1, on the other hand, relates to a high pressure process for the CO₂-reforming of hydrocarbons in the presence of Ir-containing catalysts. WO 2015/135968 A1, for its part, relates to yttrium-containing catalysts for high-temperature CO₂ hydration and/or reforming.

WO 2016/062853 A1 relates to the synthesis of aluminates by flame spray pyrolysis.

Finally, WO 2020/157202 A1 relates to a molding comprising a mixed oxide of lanthanum, aluminum, and cobalt, wherein the Co:La weight ratio is specified as being in the range of from 0.35:1 to 0.48:1.

Despite the numerous modifications which have been made in the past, there nevertheless remains the need for improved catalyst formulations, in particular with regard to their cost-efficiency, and more particularly with regard to the activation of the Co-containing catalysts for the reforming of hydrocarbons to synthesis gas.

### DETAILED DESCRIPTION

It was therefore an object of the present invention to provide a Co-containing catalyst formulation, and in particular a Co-containing catalyst formulation for the conversion of hydrocarbons to synthesis gas in the presence of steam and/or CO₂, wherein the catalyst formulation allows for a more facile activation of the Co-containing catalyst, and in particular wherein the speed at which the catalyst is activated is increased. Thus, it has surprisingly been found that a Co-containing catalyst formulation containing lanthanum, wherein the Co:La weight ratio is within a specific range allows for a substantially higher reducibility of the catalyst at low temperatures, as a results of which the activation of the catalyst is considerably improved, and may thus be achieved it a much shorter time period. As a result, it has quite unexpectedly been found that a Co-containing catalyst may be provided which is highly cost-efficient.

Therefore, the present invention relates toa composite oxide comprising oxygen, lanthanum, aluminum, and cobalt, wherein the Co:La weight ratio of cobalt relative to lanthanum in the composite oxide, calculated as the elements, is in the range of from 0.06:1 to 0.34:1, preferably of from 0.08:1 to 0.32:1, more preferably of from 0.10:1 to 0.30:1, more preferably of from 0.12:1 to 0.28:1, more preferably of from 0.14:1 to 0.26:1, more preferably of from 0.16:1 to 0.24:1, more preferably of from 0.18:1 to 0.22:1, and more preferably of from 0.20:1 to 0.21:1.

It is preferred that the composite oxide contains from 1 to 15 wt.-% of cobalt, calculated as element, more preferably from 3 to 10 wt.-%, more preferably from 4 to 8 wt.-%, more preferably from 4.5 to 7.5 wt.-%, more preferably from 5 to 7.1 wt.-%, more preferably from 5.5 to 6.9 wt.-%, more preferably from 5.7 to 6.7 wt.-%, more preferably from 5.9 to 6.5 wt.-%, and more preferably from 6.1 to 6.3 wt.-%.

It is preferred that the composite oxide contains from 5 to 50 wt.-% of lanthanum, calculated as element preferably from 10 to 45 wt.-%, more preferably from 15 to 40 wt.-%, more preferably from 20 to 38 wt.-%, more preferably from 22 to 35 wt.-%, more preferably from 24 to 32 wt.-%, more preferably from 26 to 31 wt.-%, and more preferably from 28 to 30 wt.-%.

It is preferred that the composite oxide contains from 5 to 60 wt.-% of aluminum, calculated as element, more preferably from 10 to 50 wt.-%, more preferably from 15 to 45 wt.-%, more preferably from 20 to 40 wt.-%, more preferably from 23 to 38 wt.-%, more preferably from 25 to 35 wt.-%, more preferably from 27 to 33 wt.-%, and more preferably from 29 to 31 wt.-%.

It is preferred that the Co:Al weight ratio of cobalt relative to aluminum in the composite oxide, calculated as the elements, is in the range of from 0.05:1 to 0.50:1, more preferably from 0.10:1 to 0.40:1, more preferably from 0.12:1 to 0.30:1, more preferably from 0.15:1 to 0.28:1, more preferably from 0.18:1 to 0.25:1, and more preferably from 0.20:1 to 0.22:1, more preferably in the range of from 0.205:1 to 0.22:1.

It is preferred that the composite oxide comprises an LaAl₁₋ₓCoₓO₃ phase, more preferably an LaAl₁₋ₓCoₓO₃ perovskite phase, wherein 0<x<1, and wherein x is preferably in the range of from 0.02 to 0.4, more preferably in the range of from 0.03 to 0.3. In this regard it is particularly preferred that the lattice parameter a of the LaAl₁₋ₓCoₓO₃ phase is in the range of from 3.7920 to 3.7955 Å, more preferably of from 3.7925 to 3.7950 Å, more preferably from 3.7928 to 3.7945 Å, more preferably from 3.7930 to 3.7940 Å, and more preferably from 3.7932 to 3.7935 Å, wherein the lattice parameter a of the LaAl₁₋ₓCoₓO₃ phase in the composite oxide is preferably determined according to the method of Reference Example 1. Furthermore and independently thereof, it is particularly preferred that the composite oxide comprises the LaAl₁₋ₓCoₓO₃ phase in an amount ranging from 5 to 50 wt.-% based on 100 wt.-% of the composite oxide, more preferably from 10 to 40 wt.-%, more preferably from 13 to 35 wt.-%, more preferably from 15 to 33 wt.-%, more preferably from 18 to 30 wt.-%, more preferably from 21 to 27 wt.-%, and more preferably from 23 to 25 wt.-%, wherein the amount of the LaAl₁₋ₓCoₓO₃ phase in the composite oxide is preferably determined according to the method of Reference Example 1.

It is preferred that the composite oxide comprises an LaCoAl₁₁O₁₉ phase, preferably an LaCoAl₁₁O₁₉ hexaaluminate phase.

In case where the composite oxide comprises an LaCoAl₁₁O₁₉ phase, it is preferred that the composite oxide comprises the LaCoAl₁₁O₁₉ phase in an amount ranging from 40 to 90 wt.-% based on 100 wt.-% of the composite oxide, preferably of from 50 to 80 wt.-%, more preferably from 55 to 75 wt.-%, more preferably from 58 to 70 wt.-%, more preferably from 60 to 66 wt.-%, and more preferably from 62 to 64 wt.-%, wherein the amount of the LaCoAl₁₁O₁₉ phase in the composite oxide is preferably determined according to the method of Reference Example 1.

It is preferred that the composite oxide comprises an LaAl₁₋ₓCoₓO₃ phase and an LaCoAl₁₁O₁₉ phase, wherein the LaAl₁₋ₓCoₓO₃:LaCoAl₁₁O₁₉ weight ratio of the LaAl₁₋ₓCoₓO₃ phase to the LaCoAl₁₁O₁₉ phase is in the range of from 0.05:1 to 0.70:1, preferably of from 0.1:1 to 0.60:1, more preferably from 0.15:1 to 0.55:1, more preferably from 0.20:1 to 0.50:1, more preferably from 0.25:1 to 0.48:1, more preferably from 0.30:1 to 0.45:1, more preferably from 0.35:1 to 0.42:1, and more preferably from 0.37:1 to 0.39:1, wherein the respective amounts of the LaAl₁₋ₓCoₓO₃ phase and the LaCoAl₁₁O₁₉ phase in the composite oxide is preferably determined according to the method of Reference Example 1.

It is preferred that the composite oxide comprises an La(OH)₃ phase.

In case where the composite oxide comprises an La(OH)₃ phase, it is preferred that the composite oxide comprises the La(OH)₃ phase in an amount ranging from 0.1 to 1.5 wt.-% based on 100 wt.-% of the composite oxide, more preferably from 0.3 to 1.0 wt.-%, more preferably from 0.5 to 0.8 wt.-%, and more preferably from 0.6 to 0.7 wt.-%, wherein the amount of the La(OH)₃ phase in the composite oxide is preferably determined according to the method of Reference Example 1.

It is preferred that the composite oxide comprises a CoAl₂O₄ phase, more preferably a CoAl₂O₄ spinel phase.

In case where the composite oxide comprises a CoAl₂O₄ phase, it is preferred that the composite oxide comprises the CoAl₂O₄ phase in an amount ranging from 1.0 to 10 wt.-% based on 100 wt.-% of the composite oxide, more preferably from 1.5 to 7.0 wt.-%, more preferably from 2.0 to 5.0 wt.-%, more preferably from 2.5 to 4.0 wt.-%, more preferably from 2.8 to 3.5 wt.-%, and more preferably from 3.0 to 3.2 wt.-%, wherein the amount of the CoAl₂O₄ phase in the composite oxide is preferably determined according to the method of Reference Example 1.

It is preferred that the composite oxide comprises an LaAl₁₋ₓCoₓO₃ phase and a CoAl₂O₄ phase, wherein the LaAl₁₋ₓCoₓO₃:CoAl₂O₄ phase weight ratio of the LaAl₁₋ₓCoₓO₃ phase to the CoAl₂O₄ phase is in the range of from 1.0:1 to 15:1, more preferably of from 2.0:1 to 12:1, more preferably from 4.0:1 to 10:1, more preferably from 6.0:1 to 9.0:1, more preferably from 7.0:1 to 8.5:1, more preferably from 7.5:1 to 8.2:1, and more preferably from 7.8:1 to 7.9:1, wherein the respective amounts of the LaAl₁₋ₓCoₓO₃ phase and the CoAl₂O₄ phase in the composite oxide is preferably determined according to the method of Reference Example 1.

It is preferred that the composite oxide comprises an LaCoAl₁₁O₁₉ phase and a CoAl₂O₄ phase, wherein the LaCoAl₁₁O₁₉:CoAl₂O₄ phase weight ratio of the LaCoAl₁₁O₁₉ phase to the CoAl₂O₄ phase is in the range of from 1:1 to 50:1, more preferably of from 3:1 to 45:1, more preferably from 5:1 to 40:1, more preferably from 9:1 to 35:1, more preferably from 11:1 to 30:1, more preferably from 13:1 to 28:1, more preferably from 15:1 to 26:1, more preferably from 18:1 to 24:1, and more preferably from 20:1 to 22:1, wherein the respective amounts of the LaCoAl₁₁O₁₉ phase and the CoAl₂O₄ phase in the composite oxide is preferably determined according to the method of Reference Example 1.

It is preferred that the composite oxide displays a crystallinity in the range for from 80 to 100%, more preferably of from 85 to 99%, more preferably from 88 to 97%, more preferably from 90 to 95%, and more preferably from 91 to 93%, wherein the crystallinity of the composite oxide is preferably determined according to the method of Reference Example 1.

It is preferred that from 99 to 100 weight-%, more preferably from 99.5 to 100 weight-%, more preferably from 99.9 to 100 weight-% of the composite oxide consists of oxygen, lanthanum, aluminum, cobalt, and optionally hydrogen.

It is preferred that the composite oxide is in the form of a powder or a molding, more preferably in the form of a molding.

In case where the composite oxide is in the form of a powder or a molding, it is preferred that from 99 to 100 weight-%, more preferably from 99.5 to 100 weight-%, more preferably from 99.9 to 100 weight-% of the powder or of the molding consists of the composite oxide.

It is preferred that the composite oxide is obtained or obtainable according to the process of any one of the particular and preferred embodiments of the present invention.

The present invention also relates to a method for the production of a composite oxide, preferably of a composite oxide according to any one of the particular and preferred embodiments of the present invention, the process comprising
(i) preparing a mixture of one or more sources of Al, one or more sources of Co, and one or more sources of La;
(ii) adding an acidic aqueous solution to the mixture prepared in (i);
(iii) homogenizing the mixture obtained in (ii);
(iv) optionally shaping the mixture obtained in (iii), preferably by extrusion, for obtaining a shaped body;
(v) optionally drying the mixture obtained in (iii) or the shaped body obtained in (iv);
(vi) optionally pre-calcining the mixture obtained in (iii) or (v), or the shaped body obtained in (iv) or (v);
(vii) optionally milling the dried and/or pre-calcined mixture or shaped body obtained in (v) or (vi);
(viii) optionally tableting the ground product obtained in (vii);
(ix) calcining the mixture obtained in (iii), (v), or (vi), or the shaped body obtained in (iv), (v), or (vi), or the ground product obtained in (vii), or the tableted product obtained in (viii).

Furthermore and independently thereof, it is preferred that the one or more sources of Al is selected from the group consisting of aluminum trihydroxide, Al₂O₃·0.5 H₂O, Al₂O₃, AlO(OH), more preferably boehmite, sodium aluminate, and a mixture of two or more thereof, preferably from the group consisting of gibbsite (alpha-aluminum trihydroxide), bayerite (beta-aluminum trihydroxide), nordstrandite (gamma-aluminum trihydroxide), pseudoamorphous aluminum trihydroxide, Al₂O₃·0.5 H₂O, Al₂O₃, AlO(OH), preferably boehmite, sodium aluminate, and a mixture of two or more thereof, wherein the one or more sources of alumina more preferably is AlO(OH).

It is preferred that the one or more sources of Co is selected from the group consisting of a cobalt carbonate, a cobalt oxalate, a cobalt acetate, a cobalt tartrate, a cobalt formate, a cobalt sulfate, a cobalt sulfide, a cobalt fluoride, a cobalt chloride, a cobalt bromide, and a cobalt iodide, wherein the one or more sources of Co is more preferably a cobalt carbonate, more preferably a cobalt carbonate, wherein the cobalt carbonate more preferably comprises, more preferably is CoCO₃·y H₂O, wherein 0≤y≤7, preferably 0≤y≤6.

It is preferred that the one or more sources of La is selected from the group consisting of a lanthanum carbonate, a lanthanum oxalate, a lanthanum acetate, a lanthanum tartrate, a lanthanum formate, a lanthanum sulfate, a lanthanum sulfide, a lanthanum fluoride, a lanthanum chloride, a lanthanum bromide, and a lanthanum iodide, wherein the one or more sources of La is more preferably a lanthanum carbonate, wherein the lanthanum carbonate more preferably comprises, more preferably is La₂(CO₃)₃·x H₂O, wherein 0≤x≤10, more preferably 0≤x≤6.

It is preferred that the mixture in (i) is prepared by kneading of the one or more sources of Al, Co, and La.

It is preferred that the acidic aqueous solution added in (ii) comprises one or more of formic acid, acetic acid, propionic acid, nitric acid, nitrous acid, citric acid, tartaric acid, and oxalic acid, more preferably one or more of formic acid and nitric acid, wherein the acidic aqueous solution added in (ii) more preferably comprises formic acid.

It is preferred that homogenizing in (iii) is achieved by agitating, preferably kneading, the mixture obtained in (ii).

It is preferred that drying in (v) is conducted at a temperature in the range from 80 to 150° C., more preferably in the range of from 95 to 120° C., more preferably in the range of from 100 to 110° C.

It is preferred that drying in (v) is conducted for a duration in the range from 4 to 18 h, more preferably in the range of from 6 to 12 h, more preferably in the range of from 8 to 10 h.

It is preferred that pre-calcination in (vi) is conducted at a temperature in the range from 300 to 600° C., more preferably in the range of from 350 to 500° C., more preferably in the range of from 400 to 450° C.

It is preferred that pre-calcination in (vi) is conducted for a duration in the range from 1 to 8 h, more preferably in the range of from 3 to 5 h, more preferably in the range of from 3.5 to 4.5 h.

It is preferred that calcination in (ix) is conducted at a temperature in the range from 800 to 1500° C., more preferably in the range of from 1000 to 1400° C., more preferably in the range of from 1100 to 1300° C.

It is preferred that calcination in (ix) is conducted for a duration in the range from 1 to 8 h, more preferably in the range of from 3 to 5 h, more preferably in the range of from 3.5 to 4.5 h.

In addition thereto, the present intention relates to a composite oxide as obtainable or obtained according to the method of any one of the particular and preferred embodiments of the present invention.

The present invention also relates to a method for the production of a catalyst for the conversion of hydrocarbons to synthesis gas, the process comprising
(1) providing a composite oxide according to any one of the particular and preferred embodiments of the present invention, or preparing a composite oxide according to the method of any one of the particular and preferred embodiments of the present invention;
(2) reduction of the composite oxide prepared in (1) for obtaining a catalyst.

It is preferred that reduction in (2) is conducted in an atmosphere comprising one or more reducing agents, wherein the one or more reducing agents comprise one or more of methane, hydrogen, and carbon monoxide, more preferably methane and/or hydrogen, wherein more preferably methane is employed in (2) as the reducing agent.

It is preferred that reduction in (2) is conducted at a temperature in the range of from 500 to 1,200° C., more preferably of from 600 to 1,100° C., more preferably from 700 to 1,050° C., more preferably from 750 to 1,000° C., more preferably from 800 to 950° C., and more preferably from 850 to 900° C.

It is preferred that reduction in (2) is conducted at a pressure in the range of from 5 to 40 bara, more preferably of from 10 to 35 bara, more preferably from 12 to 30 bara, more preferably from 14 to 25 bara, more preferably from 16 to 22 bara, and more preferably from 18 to 20 bara.

It is preferred that reduction in (2) is conducted for a duration in the range of from 0.5 to 24 h, more preferably of from 1 to 18 h, more preferably from 3 to 10 h, and more preferably from 5 to 7 h.

The present invention also relates to a catalyst for the conversion of hydrocarbons to synthesis gas as obtainable or obtained according to the method of any one of the particular and preferred embodiments of the present invention.

Furthermore, the present invention relates to a process for the conversion of hydrocarbons to synthesis gas, the process comprising
(A) providing a composite oxide according to any one of the particular and preferred embodiments of the present invention, or a catalyst for the conversion of hydrocarbons to synthesis gas as obtainable or obtained according to the method of any one of the particular and preferred embodiments of the present invention;
(B) preparing a gas stream comprising one or more hydrocarbons, and one or more of CO₂ and H₂O;
(C) contacting the gas stream prepared in (B) with the composite oxide provided in (A) at a temperature in the range of from 700 to 1,200° C., preferably of from 750 to 1,100° C., more preferably from 800 to 1,050° C., more preferably from 850 to 1,000° C., and more preferably from 900 to 950° C.

It is preferred that the gas stream prepared in (B) comprises one or more hydrocarbons, CO₂ and H₂O.

It is preferred that the one or more hydrocarbons are selected from the group consisting of C1-C10 alkanes, more preferably of C1-C8 alkanes, more preferably of C1-C6 alkanes, more preferably of C1-C4 alkanes, more preferably of C1-C3 alkanes, and more preferably of C1-C2 alkanes, wherein more preferably the gas stream prepared in (B) comprises one or more of methane, ethane, and propane, wherein more preferably the gas stream prepared in (B) comprises methane and/or ethane, preferably methane, wherein more preferably the one or more hydrocarbons comprised in the gas stream prepared in (B) consists of methane and/or ethane, preferable of methane.

It is preferred that the gas stream prepared in (B) comprises from 20 to 80 vol. % of the one or more hydrocarbons, more preferably from 25 to 60 vol.-%, more preferably from 30 to 50 vol.-%, more preferably from 35 to 45 vol.-%, and more preferably from 38 to 42 vol.-%.

It is preferred that the gas stream prepared in (B) comprises from 20 to 80 vol. % of CO₂, more preferably from 25 to 60 vol.-%, more preferably from 30 to 50 vol.-%, more preferably from 35 to 45 vol.-%, and more preferably from 38 to 42 vol.-%.

It is preferred that the gas stream prepared in (B) comprises from 1 to 30 vol. % of H₂O, more preferably from 5 to 25 vol.-%, more preferably from 10 to 20 vol.-%, more preferably from 12 to 18 vol.-%, and more preferably from 14 to 16 vol.-%.

It is preferred that the gas stream prepared in (B) further comprises one or more inert gases, wherein the inert gases are more preferably selected from the group consisting of noble gases, nitrogen, and mixtures of two or more thereof, wherein more preferably the gas stream further comprises nitrogen and/or argon, preferably nitrogen.

In case where the gas stream prepared in (B) further comprises one or more inert gases, it is preferred that the gas stream prepared in (B) comprises from 0 to 25 vol. % of the one or more inert gases, more preferably from 0.5 to 15 vol.-%, more preferably from 1 to 10 vol.-%, more preferably from 3 to 8 vol.-%, and more preferably from 4 to 6 vol. %.

It is preferred that contacting in (C) is conducted at a pressure in the range of from 5 to 40 bara, more preferably from 10 to 35 bara, more preferably from 12 to 30 bara, more preferably from 14 to 25 bara, more preferably from 16 to 22 bara, and more preferably from 18 to 20 bara.

It is preferred that contacting in (C) is conducted at a gas hourly space velocity in the range of from 500 to 25,000 h⁻¹, more preferably from 1,000 to 15,000 h⁻¹, more preferably from 3,000 to 10,000 h⁻¹, more preferably from 4,000 to 8,000 h⁻¹, and more preferably from 5,000 to 7,000 h⁻¹.

The present invention is further illustrated by the following set of embodiments and combi-nations of embodiments resulting from the dependencies and back-references as indicated. In particular, it is noted that in each instance where a range of embodiments is mentioned, for example in the context of a term such as “The composite oxide of any one of embodiments 1 to 4”, every embodiment in this range is meant to be explicitly disclosed for the skilled person, i.e. the wording of this term is to be understood by the skilled person as being synonymous to “The composite oxide of any one of embodiments 1, 2, 3, and 4”. Further, it is explicitly noted that the following set of embodiments is not the set of claims determining the extent of protection, but represents a suitably structured part of the description directed to general and preferred aspects of the present invention.
1. A composite oxide comprising oxygen, lanthanum, aluminum, and cobalt, wherein the Co:La weight ratio of cobalt relative to lanthanum in the composite oxide, calculated as the elements, is in the range of from 0.06:1 to 0.34:1, preferably of from 0.08:1 to 0.32:1, more preferably of from 0.10:1 to 0.30:1, more preferably of from 0.12:1 to 0.28:1, more preferably of from 0.14:1 to 0.26:1, more preferably of from 0.16:1 to 0.24:1, more preferably of from 0.18:1 to 0.22:1, and more preferably of from 0.20:1 to 0.21:1.
2. The composite oxide of embodiment 1, wherein the composite oxide contains from 1 to 15 wt.-% of cobalt, calculated as element, preferably from 3 to 10 wt.-%, more preferably from 4 to 8 wt.-%, more preferably from 4.5 to 7.5 wt.-%, more preferably from 5 to 7.1 wt.-%, more preferably from 5.5 to 6.9 wt.-%, more preferably from 5.7 to 6.7 wt.-%, more preferably from 5.9 to 6.5 wt.-%, and more preferably from 6.1 to 6.3 wt.-%.
3. The composite oxide of embodiment 1 or 2, wherein the composite oxide contains from 5 to 50 wt.-% of lanthanum, calculated as element preferably from 10 to 45 wt.-%, more preferably from 15 to 40 wt.-%, more preferably from 20 to 38 wt.-%, more preferably from 22 to 35 wt.-%, more preferably from 24 to 32 wt.-%, more preferably from 26 to 31 wt.-%, and more preferably from 28 to 30 wt.-%.
4. The composite oxide of any one of embodiments 1 to 3, wherein the composite oxide contains from 5 to 60 wt.-% of aluminum, calculated as element, preferably from 10 to 50 wt.-%, more preferably from 15 to 45 wt.-%, more preferably from 20 to 40 wt.-%, more preferably from 23 to 38 wt.-%, more preferably from 25 to 35 wt.-%, more preferably from 27 to 33 wt.-%, and more preferably from 29 to 31 wt.-%.
5. The composite oxide of any one of embodiments 1 to 4, wherein the Co:Al weight ratio of cobalt relative to aluminum in the composite oxide, calculated as the elements, is in the range of from 0.05:1 to 0.50:1, preferably from 0.10:1 to 0.40:1, more preferably from 0.12:1 to 0.30:1, more preferably from 0.15:1 to 0.28:1, more preferably from 0.18:1 to 0.25:1, and more preferably from 0.20:1 to 0.22:1, more preferably in the range of from 0.205:1 to 0.22:1.
6. The composite oxide of any one of embodiments 1 to 5, wherein the composite oxide comprises an LaAl₁₋ₓCoₓO₃ phase, preferably an LaAl₁₋ₓCoₓO₃ perovskite phase, wherein 0<x<1, and wherein x is preferably in the range of from 0.02 to 0.4, more preferably in the range of from 0.03 to 0.3.
7. The composite oxide of embodiment 6, wherein the lattice parameter a of the LaAl₁₋ₓCoₓO₃ phase is in the range of from 3.7920 to 3.7955 Å, preferably of from 3.7925 to 3.7950 Å, more preferably from 3.7928 to 3.7945 Å, more preferably from 3.7930 to 3.7940 Å, and more preferably from 3.7932 to 3.7935 Å,
   wherein the lattice parameter a of the LaAl₁₋ₓCoₓO₃ phase in the composite oxide is preferably determined according to the method of Reference Example 1.
8. The composite oxide of embodiment 6 or 7, wherein the composite oxide comprises the LaAl₁₋ₓCoₓO₃ phase in an amount ranging from 5 to 50 wt.-% based on 100 wt.-% of the composite oxide, preferably from 10 to 40 wt.-%, more preferably from 13 to 35 wt.-%, more preferably from 15 to 33 wt.-%, more preferably from 18 to 30 wt.-%, more preferably from 21 to 27 wt.-%, and more preferably from 23 to 25 wt.-%,
   wherein the amount of the LaAl₁₋ₓCoₓO₃ phase in the composite oxide is preferably determined according to the method of Reference Example 1.
9. The composite oxide of any one of embodiments 1 to 8, wherein the composite oxide comprises an LaCoAl₁₁O₁₉ phase, preferably an LaCoAl₁₁O₁₉ hexaaluminate phase.
10. The composite oxide of embodiment 9, wherein the composite oxide comprises the LaCoAl₁₁O₁₉ phase in an amount ranging from 40 to 90 wt.-% based on 100 wt.-% of the composite oxide, preferably of from 50 to 80 wt.-%, more preferably from 55 to 75 wt.-%, more preferably from 58 to 70 wt.-%, more preferably from 60 to 66 wt.-%, and more preferably from 62 to 64 wt.-%,
   wherein the amount of the LaCoAl₁₁O₁₉ phase in the composite oxide is preferably determined according to the method of Reference Example 1.
11. The composite oxide of any one of embodiments 1 to 10, wherein the composite oxide comprises an LaAl₁₋ₓCoₓO₃ phase and an LaCoAl₁₁O₁₉ phase, wherein the LaAl₁₋ₓCoₓO₃:LaCoAl₁₁O₁₉ weight ratio of the LaAl₁₋ₓCoₓO₃ phase to the LaCoAl₁₁O₁₉ phase is in the range of from 0.05:1 to 0.70:1, preferably of from 0.1:1 to 0.60:1, more preferably from 0.15:1 to 0.55:1, more preferably from 0.20:1 to 0.50:1, more preferably from 0.25:1 to 0.48:1, more preferably from 0.30:1 to 0.45:1, more preferably from 0.35:1 to 0.42:1, and more preferably from 0.37:1 to 0.39:1,
   wherein the respective amounts of the LaAl₁₋ₓCoₓO₃ phase and the LaCoAl₁₁O₁₉ phase in the composite oxide is preferably determined according to the method of Reference Example 1.
12. The composite oxide of any one of embodiments 1 to 11, wherein the composite oxide comprises an La(OH)₃ phase.
13. The composite oxide of embodiment 12, wherein the composite oxide comprises the La(OH)₃ phase in an amount ranging from 0.1 to 1.5 wt.-% based on 100 wt.-% of the composite oxide, preferably from 0.3 to 1.0 wt.-%, more preferably from 0.5 to 0.8 wt.-%, and more preferably from 0.6 to 0.7 wt.-%,
   wherein the amount of the La(OH)₃ phase in the composite oxide is preferably determined according to the method of Reference Example 1.
14. The composite oxide of any one of embodiments 1 to 13, wherein the composite oxide comprises a CoAl₂O₄ phase, preferably a CoAl₂O₄ spinel phase.
15. The composite oxide of embodiment 14, wherein the composite oxide comprises the CoAl₂O₄ phase in an amount ranging from 1.0 to 10 wt.-% based on 100 wt.-% of the composite oxide, preferably from 1.5 to 7.0 wt.-%, more preferably from 2.0 to 5.0 wt.-%, more preferably from 2.5 to 4.0 wt.-%, more preferably from 2.8 to 3.5 wt.-%, and more preferably from 3.0 to 3.2 wt.-%,
   wherein the amount of the CoAl₂O₄ phase in the composite oxide is preferably determined according to the method of Reference Example 1.
16. The composite oxide of any one of embodiments 1 to 15, wherein the composite oxide comprises an LaAl₁₋ₓCoₓO₃ phase and a CoAl₂O₄ phase, wherein the LaAl₁₋ₓCoₓO₃:CoAl₂O₄ phase weight ratio of the LaAl₁₋ₓCoₓO₃ phase to the CoAl₂O₄ phase is in the range of from 1.0:1 to 15:1, preferably of from 2.0:1 to 12:1, more preferably from 4.0:1 to 10:1, more preferably from 6.0:1 to 9.0:1, more preferably from 7.0:1 to 8.5:1, more preferably from 7.5:1 to 8.2:1, and more preferably from 7.8:1 to 7.9:1,
   wherein the respective amounts of the LaAl₁₋ₓCoₓO₃ phase and the CoAl₂O₄ phase in the composite oxide is preferably determined according to the method of Reference Example 1.
17. The composite oxide of any one of embodiments 1 to 16, wherein the composite oxide comprises an LaCoAl₁₁O₁₉ phase and a CoAl₂O₄ phase, wherein the LaCoAl₁₁O₁₉:CoAl₂O₄ phase weight ratio of the LaCoAl₁₁O₁₉ phase to the CoAl₂O₄ phase is in the range of from 1:1 to 50:1, preferably of from 3:1 to 45:1, more preferably from 5:1 to 40:1, more preferably from 9:1 to 35:1, more preferably from 11:1 to 30:1, more preferably from 13:1 to 28:1, more preferably from 15:1 to 26:1, more preferably from 18:1 to 24:1, and more preferably from 20:1 to 22:1,
   wherein the respective amounts of the LaCoAl₁₁O₁₉ phase and the CoAl₂O₄ phase in the composite oxide is preferably determined according to the method of Reference Example 1.
18. The composite oxide of any one of embodiments 1 to 17, wherein the composite oxide displays a crystallinity in the range for from 80 to 100%, preferably of from 85 to 99%, more preferably from 88 to 97%, more preferably from 90 to 95%, and more preferably from 91 to 93%,
   wherein the crystallinity of the composite oxide is preferably determined according to the method of Reference Example 1.
19. The composite oxide of any one of embodiments 1 to 18, wherein from 99 to 100 weight-%, preferably from 99.5 to 100 weight-%, more preferably from 99.9 to 100 weight-% of the composite oxide consists of oxygen, lanthanum, aluminum, cobalt, and optionally hydrogen.
20. The composite oxide of any one of embodiments 1 to 19, wherein the composite oxide is in the form of a powder or a molding, preferably in the form of a molding.
21. The composite oxide of embodiment 20, wherein from 99 to 100 weight-%, preferably from 99.5 to 100 weight-%, more preferably from 99.9 to 100 weight-% of the powder or of the molding consists of the composite oxide.
22. The composite oxide of any one of embodiments 1 to 21, wherein the composite oxide is obtained or obtainable according to the process of any one of embodiments 23 to 39.
23. A method for the production of a composite oxide, preferably of a composite oxide according to any one of embodiments 1 to 21, the process comprising
   (i) preparing a mixture of one or more sources of Al, one or more sources of Co, and one or more sources of La;
   (ii) adding an acidic aqueous solution to the mixture prepared in (i);
   (iii) homogenizing the mixture obtained in (ii);
   (iv) optionally shaping the mixture obtained in (iii), preferably by extrusion, for obtaining a shaped body;
   (v) optionally drying the mixture obtained in (iii) or the shaped body obtained in (iv);
   (vi) optionally pre-calcining the mixture obtained in (iii) or (v), or the shaped body obtained in (iv) or (v);
   (vii) optionally milling the dried and/or pre-calcined mixture or shaped body obtained in (v) or (vi);
   (viii) optionally tableting the ground product obtained in (vii);
   (ix) calcining the mixture obtained in (iii), (v), or (vi), or the shaped body obtained in (iv), (v), or (vi), or the ground product obtained in (vii), or the tableted product obtained in (viii).
24. The method of embodiment 23, wherein the one or more sources of Al is selected from the group consisting of aluminum trihydroxide, Al₂O₃·0.5 H₂O, Al₂O₃, AlO(OH), preferably boehmite, sodium aluminate, and a mixture of two or more thereof, preferably from the group consisting of gibbsite (alpha-aluminum trihydroxide), bayerite (beta-aluminum trihydroxide), nordstrandite (gamma-aluminum trihydroxide), pseudoamorphous aluminum trihydroxide, Al₂O₃·0.5 H₂O, Al₂O₃, AlO(OH), preferably boehmite, sodium aluminate, and a mixture of two or more thereof, wherein the one or more sources of alumina more preferably is AlO(OH).
25. The method of embodiment 23 or 24, wherein the one or more sources of Co is selected from the group consisting of a cobalt carbonate, a cobalt oxalate, a cobalt acetate, a cobalt tartrate, a cobalt formate, a cobalt sulfate, a cobalt sulfide, a cobalt fluoride, a cobalt chloride, a cobalt bromide, and a cobalt iodide, wherein the one or more sources of Co is preferably a cobalt carbonate, more preferably a cobalt carbonate, wherein the cobalt carbonate more preferably comprises, more preferably is CoCO₃·y H₂O, wherein 0≤y≤7, preferably 0≤y≤6.
26. The method of any one of embodiments 23 to 25, wherein the one or more sources of La is selected from the group consisting of a lanthanum carbonate, a lanthanum oxalate, a lanthanum acetate, a lanthanum tartrate, a lanthanum formate, a lanthanum sulfate, a lanthanum sulfide, a lanthanum fluoride, a lanthanum chloride, a lanthanum bromide, and a lanthanum iodide, wherein the one or more sources of La is preferably a lanthanum carbonate, wherein the lanthanum carbonate more preferably comprises, more preferably is La₂(CO₃)₃·x H₂O, wherein 0≤x≤10, more preferably 0≤x≤6.
27. The method of any one of embodiments 23 to 26, wherein the mixture in (i) is prepared by kneading of the one or more sources of Al, Co, and La.
28. The method of any one of embodiments 23 to 27, wherein the acidic aqueous solution added in (ii) comprises one or more of formic acid, acetic acid, propionic acid, nitric acid, nitrous acid, citric acid, tartaric acid, and oxalic acid, preferably one or more of formic acid and nitric acid, wherein the acidic aqueous solution added in (ii) more preferably comprises formic acid.
29. The method of any one of embodiments 23 to 28, wherein homogenizing in (iii) is achieved by agitating, preferably kneading, the mixture obtained in (ii).
30. The method of any one of embodiments 23 to 29, wherein drying in (v) is conducted at a temperature in the range from 80 to 150° C., preferably in the range of from 95 to 120° C., more preferably in the range of from 100 to 110° C.
31. The method of any one of embodiments 23 to 30, wherein drying in (v) is conducted for a duration in the range from 4 to 18 h, preferably in the range of from 6 to 12 h, more preferably in the range of from 8 to 10 h.
32. The method of any one of embodiments 23 to 31, wherein pre-calcination in (vi) is conducted at a temperature in the range from 300 to 600° C., preferably in the range of from 350 to 500° C., more preferably in the range of from 400 to 450° C.
33. The method of any one of embodiments 23 to 32, wherein pre-calcination in (vi) is conducted for a duration in the range from 1 to 8 h, preferably in the range of from 3 to 5 h, more preferably in the range of from 3.5 to 4.5 h.
34. The method of any one of embodiments 23 to 33, wherein calcination in (ix) is conducted at a temperature in the range from 800 to 1500° C., preferably in the range of from 1000 to 1400° C., more preferably in the range of from 1100 to 1300° C.
35. The method of any one of embodiments 23 to 34, wherein calcination in (ix) is conducted for a duration in the range from 1 to 8 h, preferably in the range of from 3 to 5 h, more preferably in the range of from 3.5 to 4.5 h.
36. A composite oxide as obtainable or obtained according to the method of any one of embodiments 23 to 35.
37. A method for the production of a catalyst for the conversion of hydrocarbons to synthesis gas, the process comprising
   (1) providing a composite oxide according to any one of embodiments 1 to 22 and 36, or preparing a composite oxide according to the method of any one of embodiments 23 to 35;
   (2) reduction of the composite oxide prepared in (1) for obtaining a catalyst.
38. The method of embodiment 37, wherein reduction in (2) is conducted in an atmosphere comprising one or more reducing agents, wherein the one or more reducing agents comprise one or more of methane, hydrogen, and carbon monoxide, preferably methane and/or hydrogen, wherein more preferably methane is employed in (2) as the reducing agent.
39. The method of embodiment 37 or 38, wherein reduction in (2) is conducted at a temperature in the range of from 500 to 1,200° C., preferably of from 600 to 1,100° C., more preferably from 700 to 1,050° C., more preferably from 750 to 1,000° C., more preferably from 800 to 950° C., and more preferably from 850 to 900° C.
40. The method of any one of embodiments 37 to 39, wherein reduction in (2) is conducted at a pressure in the range of from 5 to 40 bara, preferably of from 10 to 35 bara, more preferably from 12 to 30 bara, more preferably from 14 to 25 bara, more preferably from 16 to 22 bara, and more preferably from 18 to 20 bara.
41. The method of any one of embodiments 37 to 40, wherein reduction in (2) is conducted for a duration in the range of from 0.5 to 24 h, preferably of from 1 to 18 h, more preferably from 3 to 10 h, and more preferably from 5 to 7 h.
42. A catalyst for the conversion of hydrocarbons to synthesis gas as obtainable or obtained according to the method of any one of embodiments 37 to 41.
43. A process for the conversion of hydrocarbons to synthesis gas, the process comprising
   (A) providing a composite oxide according to any one of embodiments 1 to 22 and 36, or a catalyst according to embodiment 42;
   (B) preparing a gas stream comprising one or more hydrocarbons, and one or more of CO₂ and H₂O;
   (C) contacting the gas stream prepared in (B) with the composite oxide provided in (A) at a temperature in the range of from 700 to 1,200° C., preferably of from 750 to 1,100° C., more preferably from 800 to 1,050° C., more preferably from 850 to 1,000° C., and more preferably from 900 to 950° C.
44. The process of embodiment 43, wherein the gas stream prepared in (B) comprises one or more hydrocarbons, CO₂ and H₂O.
45. The process of embodiment 43 or 44, wherein the one or more hydrocarbons are selected from the group consisting of C1-C10 alkanes, preferably of C1-C8 alkanes, more preferably of C1-C6 alkanes, more preferably of C1-C4 alkanes, more preferably of C1-C3 alkanes, and more preferably of C1-C2 alkanes, wherein more preferably the gas stream prepared in (B) comprises one or more of methane, ethane, and propane, wherein more preferably the gas stream prepared in (B) comprises methane and/or ethane, preferably methane, wherein more preferably the one or more hydrocarbons comprised in the gas stream prepared in (B) consists of methane and/or ethane, preferable of methane.
46. The process of any one of embodiments 43 to 45, wherein the gas stream prepared in (B) comprises from 20 to 80 vol. % of the one or more hydrocarbons, preferably from 25 to 60 vol.-%, more preferably from 30 to 50 vol.-%, more preferably from 35 to 45 vol.-%, and more preferably from 38 to 42 vol.-%.
47. The process of any one of embodiments 43 to 46, wherein the gas stream prepared in (B) comprises from 20 to 80 vol. % of CO₂, preferably from 25 to 60 vol.-%, more preferably from 30 to 50 vol.-%, more preferably from 35 to 45 vol.-%, and more preferably from 38 to 42 vol.-%.
48. The process of any one of embodiments 43 to 47, wherein the gas stream prepared in (B) comprises from 1 to 30 vol. % of H₂O, preferably from 5 to 25 vol.-%, more preferably from 10 to 20 vol.-%, more preferably from 12 to 18 vol.-%, and more preferably from 14 to 16 vol.-%.
49. The process of any one of embodiments 43 to 48, wherein the gas stream prepared in (B) further comprises one or more inert gases, wherein the inert gases are preferably selected from the group consisting of noble gases, nitrogen, and mixtures of two or more thereof, wherein more preferably the gas stream further comprises nitrogen and/or argon, preferably nitrogen.
50. The process of embodiment 49, wherein the gas stream prepared in (B) comprises from 0 to 25 vol. % of the one or more inert gases, preferably from 0.5 to 15 vol.-%, more preferably from 1 to 10 vol.-%, more preferably from 3 to 8 vol.-%, and more preferably from 4 to 6 vol. %.
51. The process of any one of embodiments 43 to 50, wherein contacting in (C) is conducted at a pressure in the range of from 5 to 40 bara, preferably from 10 to 35 bara, more preferably from 12 to 30 bara, more preferably from 14 to 25 bara, more preferably from 16 to 22 bara, and more preferably from 18 to 20 bara.
52. The process of any one of embodiments 43 to 51, wherein contacting in (C) is conducted at a gas hourly space velocity in the range of from 500 to 25,000 h⁻¹, preferably from 1,000 to 15,000 h⁻¹, more preferably from 3,000 to 10,000 h⁻¹, more preferably from 4,000 to 8,000 h⁻¹, and more preferably from 5,000 to 7,000 h⁻¹.

### DESCRIPTION OF THE FIGURES

FIG. 1 displays the results from TPR analysis of the samples from Comparative Example 1 and Examples 4 to 6 as performed according to Reference Example 2, respectively. In the Figure, the time in minutes is plotted along the abscissa.

FIG. 2 displays the results from TPR analysis of the samples from Comparative Example 1 and Examples 4 to 6 as performed according to Reference Example 2, respectively. In the Figure, the temperature in ° C. is plotted along the abscissa.

FIG. 3 displays the results from TPR analysis of the samples from Comparative Examples 2 and 8 and Examples 7 and 9 as performed according to Reference Example 2, respectively. In the Figure, the temperature in ° C. is plotted along the abscissa.

FIG. 4 displays the results from catalyst testing according to Example 10 as performed on the samples from Comparative Examples 1 and 2 and Examples 3, 5, and 6. In the Figure, the conversion of methane in % is plotted along the ordinate, and the time on stream of the catalyst in hours is plotted along the abscissa.

FIG. 5 displays the results from catalyst testing according to Example 10 as performed on the samples from Comparative Examples 1 and 2 and Examples 3, 5, and 6. In the Figure, the conversion of CO₂ in % is plotted along the ordinate, and the time on stream of the catalyst in hours is plotted along the abscissa.

### EXPERIMENTAL SECTION

The present invention is further illustrated by the following Examples, Comparative Examples and Reference Examples.

### Reference Example 1: Compositional and Structural Analysis Via X-Ray Diffraction

Powder X-ray Diffraction (PXRD) data were collected using a laboratory diffractometer (D8 Discover, Bruker AXS GmbH, Karlsruhe). The instrument was set up with a Molybdenum X-ray tube (40 mA, 40 kV). The characteristic K-alpha radiation was monochromatized using a bent Germanium Johansson type primary monochromator. Data were collected in the Bragg-Brentano reflection geometry (2-40° (2θ), 0.02° step size, 2.4 s/step). A LYNXEYE XE area detector was utilized to collect the scattered X-ray signal. The powders were ground using an IKA Tube Mill and an MT40.100 disposable grinding chamber. The powder was placed in a sample holder and flattened using a glass plate. Data analysis was performed using DIFFRAC.EVA V4 and DIFFRAC.TOPAS V4 software (Bruker AXS GmbH). DIF-FRAC.EVA was used to estimate the crystallinity. Default values were used as input for the algorithm (DIFFRAC.EVA User Manual, 2014, Bruker AXS GmbH, Karlsruhe). All other parameters were determined using DIFFRAC.TOPAS. The entire diffraction pattern was simulated using the crystal structures of hexagonal LaCoAl₁₁O₁₉, rhombohedral LaAlO₃, cubic CoAl₂O₄, hexagonal La(OH)₃, cubic Co-doped LaAl₃ and Corundum. During the simulation, 29 parameters were refined to fit the simulated diffraction to the measured data. The parameters are listed in the following Table 1.

TABLE 1
Parameters for refining

| Parameter | Structure | No. of variables |
|---|---|---|
| Background via Chebychev | global | 2 |
| polynomial | | |
| Background via peak at ca. | global | 3 |
| 6.6° 2theta | | |
| Specimen displacement | global | 1 |
| | hexagonal LaCoAl₁₁O₁₉ | |
| Crystallite size | | 1 |
| Scale factor | | 1 |
| Lattice | | 2 |
| Preferred orientation* | | 1 |
| | cubic Co-doped LaAlO₃ | |
| Crystallite size | | 1 |
| Scale factor | | 1 |
| Lattice | | 1 |
| Co doping factor | | 1 |
| | rhombohedral LaAlO₃ | |
| Crystallite size | | 1 |
| Scale factor | | 1 |
| Lattice | | 2 |
| | Corundum | |
| Crystallite size | | 1 |
| Scale factor | | 1 |
| Lattice | | 2 |
| | cubic CoAl₂O₄ | |
| Crystallite size | | 1 |
| Scale factor | | 1 |
| Lattice | | 1 |
| | hexagonal La(OH)₃ | |
| Scale factor | | 1 |
| Lattice | | 2 |

*Using the March-Dollase model along the (1 1 0) direction.

All crystal structures used were retrieved from the inorganic crystal structure database (ICSD) (ICSD, FIZ Karlsruhe (https://icsd.fiz-karlsruhe.de/)) or the Pearson's Crystal Data (PCD) (Pearson's Crystal Data—Crystal Structure Database for Inorganic Compounds, Re-lease 2016/2017, ASM International, Materials Park, Ohio, USA). The following Table 2 lists the reference numbers of the structures used.

TABLE 2
Numbers of structures used

| | ICSD Number | PCD Number |
|---|---|---|
| hexagonal LaCoAl₁₁O₁₉ | | 1502158 |
| cubic Co-doped LaAlO₃ | | 1501066 |
| rhombohedral LaAlO₃ | 28629 | |
| Corundum | | 1520618 |
| cubic CoAl₂O₄ | 163275 | |
| hexagonal La(OH)₃ | 192271 | |
| cubic LaAlO₃ | 170772 | |

The crystallite size values are those reported as Lvol-FWHM in DIFFRAC.TOPAS. To ensure reliable crystallite size values the geometry of the diffractometer was entered into the software to enable the calculation of the instrumental resolution based on the fundamental parameter approach (DIFFRAC.TOPAS User Manual, 2014, Bruker AXS GmbH, Karlsruhe). Scale factors were recomputed into mass percent values by DIFFRAC.TOPAS and have been reported.

### Reference Example 2: Temperature Programmed Reduction (TPR) Analysis

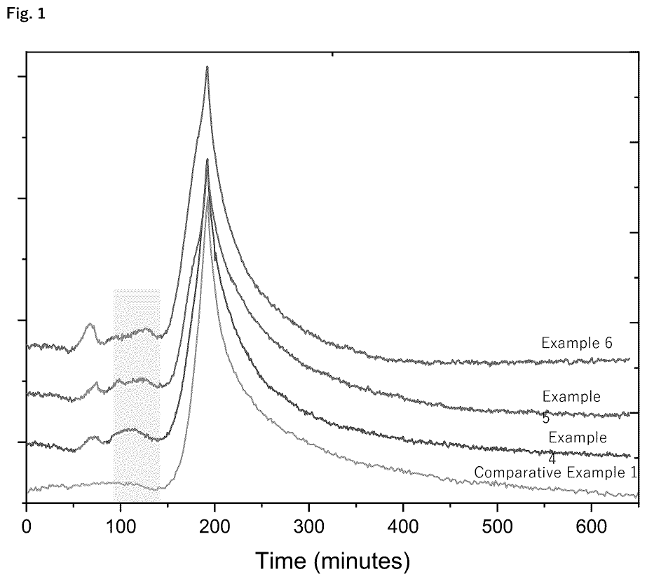

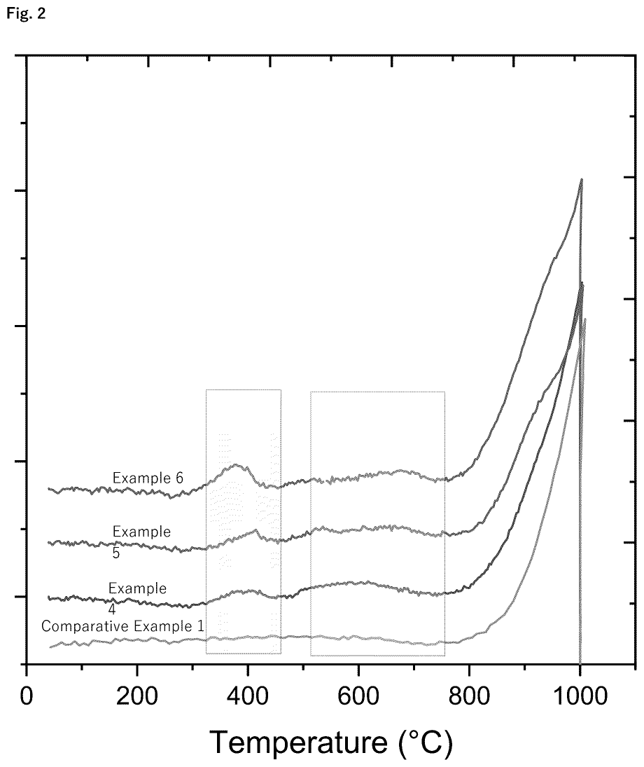

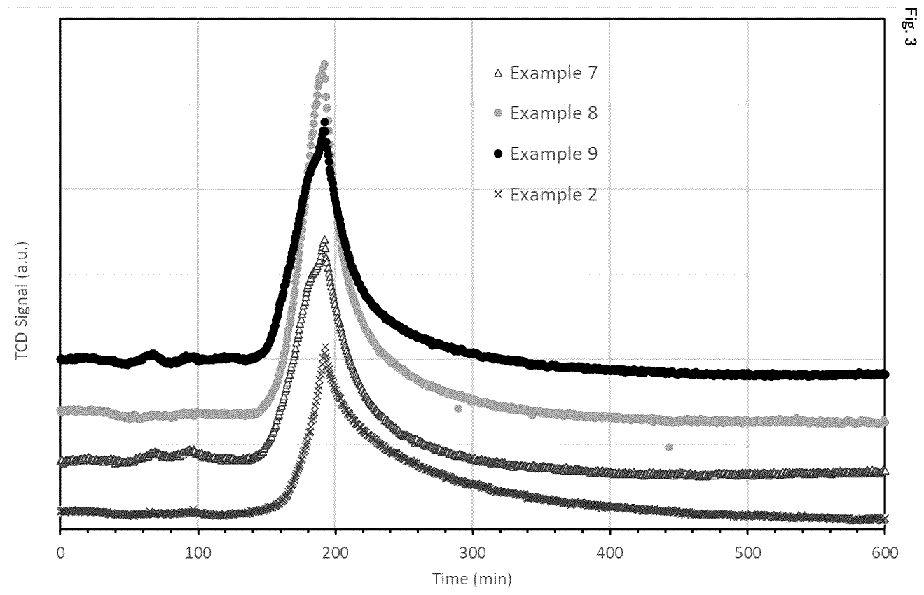

The reduction behavior of a molding was determined by temperature programmed reduction. 190 mg of a sample having particles with an average particle size between 0.2 and 0.4 mm were used. As a feed gas a stream of 5 volume-% hydrogen in Argon was used, whereby the feed rate was set to 50 ml/min. The temperature was increased during a measurement from room temperature up to 950° C. with a heating rate of 5 K/min. The thermal conductivity detector (TCD) signal was recorded relative to the temperature to give the TPR profile. The TPR profiles of Examples 4-6, and Comparative Example 1 are shown in FIGS. 1 and 2, and those of Examples 7 and 9 and Comparative Examples 2 and 8 are shown in FIG. 3.

### Comparative Example 1: Preparation of a Composite Oxide of Co, La, and Al

70 kg aqueous AlOOH (Disperal; Sasol; containing 77.6 weight-% of Al calculated as Al₂O₃), 13.04 kg cobalt(II)carbonate hydrate (containing 55.92 weight-% of Co, calculated as CoO; Umicore), 34.37 kg lanthanum(III)carbonate hydrate (containing 49.26 weight-% La calculated as La₂O₃; Inner Mongolia) were pre-mixed for several minutes in a Koller or in a mixer.

Then, 50.79 kg aqueous formic acid (containing 37 weight-% formic acid; based on formic acid having 98-100 weight-%, Bernd Kraft GmbH, CAS #: 64-18-6) were added in three portions, wherein the first portion contains about 50 weight-%, the second and the third portion each about 25 weight-% of the total aqueous formic acid, under mixing and a dough-like homogeneous pink mass was formed. The appropriate amounts of Disperal, CoCO₃, La₂(CO₃)₃ and 37 wt % aqueous HCOOH were mixed in a kneader. The kneading mass was then shaped into 4 mm ropes. The ropes were dried at 90° C. for 10 h, subsequently calcined for 4 h at 400° C. The Extrudates went through a tableting step to form quadrilobed tablets. Thereafter, the calcined extrudates were grinded. Then, the material was sieved using sieves with a mesh of 1000 micrometer. The sieved powder was then mixed with 3 weight-% graphite (Asbury Graphite 3160) and 3 weight-% microcrystalline cellulose (Vivapur SCG102). The resulting mixture was tableted to moldings having a four-hole cross-section. The diameter of a molding was 16.74 mm and the height was 9.84 mm. The Tablets were calcined.

For calcination, the moldings were heated within 3 hours to a temperature of 700° C. and said temperature was held for 1 hour. Then, the moldings were heated further to a temperature in the range of from 1170 to 1200° C., and the temperature was held in this range for 4 hours. The calcination was done in an annealing furnace.

Then, the moldings were split into particles having an inner diameter of 0.5-1 mm.

### Comparative Example 2: Preparation of a Composite Oxide of Co, La, and Al

30.7 kg aqueous AlOOH (Disperal; Sasol; containing 77.9 weight-% of Al calculated as Al₂O₃), 5.5 kg cobalt(II)carbonate hydrate (containing 46 weight-% of Co; Umicore, Todini), 16.1 kg lanthanum(III)carbonate hydrate (containing 39.3 weight-% La; Mongolia Baotuo Steel Rare Earth Int. trade co. ltd) were pre-mixed for several minutes in a kneader. Then, 23 kg aqueous formic acid (containing 37 weight-% formic acid; based on formic acid having 98-100 weight-%, BASF SE) were added under mixing and a dough-like homogeneous pink mass was formed.

The kneading mass was then shaped into 6 mm ropes. The ropes were dried at 95-120° C. for 10 h, subsequently calcined for 4 h at 400-440° C. then split into particles having an inner diameter of 0.5-1 mm. Prior to catalytic testing the split was calcined. For calcination, the moldings were heated within 3 hours to a temperature of 700° C. and said temperature was held for 1 hour. Then the moldings were heated further to a temperature of 1200° C., and the temperature was held for 4 hours. The calcination was done in an annealing furnace.

### Example 3: Preparation of a Composite Oxide of Co, La, and Al

162.36 g aqueous AlOOH (Disperal; Sasol; containing 71.6 weight-% of Al calculated as Al₂O₃), 29.59 g cobalt(II)carbonate hydrate (containing 46 weight-% of Co; abcr_Germany_GmbH), 97.57 g lanthanum(III)carbonate hydrate (containing 41 weight-% La; Alfa_Aesar_USA_GmbH&CoKG) were pre-mixed for several minutes in a Kneader. Then, 140 ml aqueous formic acid (containing 37 weight-% formic acid; based on formic acid having 98-100 weight-%, Bernd Kraft GmbH) were added under mixing and a dough-like homogeneous pink mass was formed.

The kneading mass was then shaped into 3.5 mm ropes. The ropes were dried at 90° C. for 16 h, subsequently calcined for 4 h at 400° C. and then split into particles having an inner diameter of 0.5-1 mm. Prior to catalytic testing the split was calcined. For calcination, the moldings were heated within 3 hours to a temperature of 700° C. and said temperature was held for 1 hour. Then the moldings were heated further to a temperature of 1200° C., and the temperature was held for 4 hours. The calcination was done in an annealing furnace.

### Example 4: Preparation of a Composite Oxide of Co, La, and Al

165.8 g aqueous AlOOH (Disperal; Sasol; containing 77.6 weight-% of Al calculated as Al₂O₃), 30.9 g cobalt(II)carbonate hydrate (containing 45 weight-% of Co; ABCR lot1102550), 119.5 g lanthanum(III)carbonate hydrate (containing 41 weight-% La; Alfa Aesar lotY04D030) were pre-mixed for several minutes in a Kneader. Then, 120 ml aqueous formic acid (containing 30 weight-% formic acid; based on formic acid having 98-100 weight-%, Bernd Kraft GmbH) were added under mixing and a dough-like homogeneous pink mass was formed.

The kneading mass was then shaped into 3.5 mm ropes. The ropes were dried at 90° C. for 16 h, subsequently calcined for 4 h at 400° C. and then split into particles having an inner diameter of 0.5-1 mm. Prior to catalytic testing the split was calcined. For calcination, the moldings were heated within 3 hours to a temperature of 700° C. and said temperature was held for 1 hour. Then the moldings were heated further to a temperature of 1200° C., and the temperature was held for 4 hours. The calcination was done in an annealing furnace.

### Example 5: Preparation of a Composite Oxide of Co, La, and Al

155.8 g aqueous AlOOH (Disperal; Sasol; containing 77.9 weight-% of Al calculated as Al₂O₃), 29.7 g cobalt(II)carbonate hydrate (containing 46 weight-% of Co; ABCR lot1102550), 132.1 g lanthanum(III)carbonate hydrate (containing 41 weight-% La; Alfa Aesar lotY04D030) were pre-mixed for several minutes in a Kneader. Then, 140 ml aqueous formic acid (containing 37 weight-% formic acid; based on formic acid having 98-100 weight-%, Bernd Kraft GmbH) were added under mixing and a dough-like homogeneous pink mass was formed.

The kneading mass was then shaped into 3.5 mm ropes. The ropes were dried at 90° C. for 16 h, subsequently calcined for 4 h at 400° C. and then split into particles having an inner diameter of 0.5-1 mm. Prior to catalytic testing the split was calcined. For calcination, the moldings were heated within 3 hours to a temperature of 700° C. and said temperature was held for 1 hour. Then the moldings were heated further to a temperature of 1200° C., and the temperature was held for 4 hours. The calcination was done in an annealing furnace.

### Example 6: Preparation of a Composite Oxide of Co, La, and Al

151.9 g aqueous AlOOH (Disperal; Sasol; containing 77.9 weight-% of Al calculated as Al₂O₃), 29.7 g cobalt(II)carbonate hydrate (containing 46 weight-% of Co; ABCR lot1102550), 152.5 g lanthanum(III)carbonate hydrate (containing 41 weight-% La; Alfa Aesar lotY04D030) were pre-mixed for several minutes in a Kneader. Then, 140 ml aqueous formic acid (containing 51 weight-% formic acid; based on formic acid having 98-100 weight-%, Bernd Kraft GmbH) were added under mixing and a dough-like homogeneous pink mass was formed.

The kneading mass was then shaped into 3.5 mm ropes. The ropes were dried at 90° C. for 16 h, subsequently calcined for 4 h at 400° C. and then split into particles having an inner diameter of 0.5-1 mm. Prior to catalytic testing the split was calcined. For calcination, the moldings were heated within 3 hours to a temperature of 700° C. and said temperature was held for 1 hour. Then the moldings were heated further to a temperature of 1200° C., and the temperature was held for 4 hours. The calcination was done in an annealing furnace.

### Example 7: Preparation of a Composite Oxide of Co, La and Al

160 g aqueous AlOOH (Disperal; Sasol; containing 77.6 weight-% of Al calculated as Al₂O₃), 31.1 g cobalt(II)carbonate hydrate (containing 46 weight-% of Co; Umicore lot29371A0205/BASF SE), 160.1 lanthanum(III)carbonate hydrate (containing 41 weight-% La; Mongolia Baotuo Steel Rare Earth Int. trade co. ltd) were pre-mixed for several minutes in a Kneader. Then, 140 ml aqueous formic acid (containing 51 weight-% formic acid; based on formic acid having 98-100 weight-%, Bernd Kraft GmbH) were added under mixing and a dough-like homogeneous pink mass was formed.

The kneading mass was then shaped into 3.5 mm ropes. The ropes were dried at 90° C. for 16 h, subsequently calcined for 4 h at 400° C. and then splitted into particles having an inner diameter of 0.5-1 mm. Prior to catalytic testing the split was calcined. For calcination, the moldings were heated within 3 hours to a temperature of 700° C. and said temperature was held for 1 hour. Then the moldings were heated further to a temperature of 1200° C., and the temperature was held for 4 hours. The calcination was done in an annealing furnace.

### Comparative Example 8: Preparation of a Composite Oxide of Co, La, and Al

160 g aqueous AlOOH (Disperal; Sasol; containing 77.6 weight-% of Al calculated as Al₂O₃), 28.6 g cobalt(II)carbonate hydrate (containing 46 weight-% of Co; Umicore lot29371A0205 BASF SE), 80.5 g lanthanum(III)carbonate hydrate (containing 41 weight-% La; Mongolia Baotuo Steel Rare Earth Int. trade co. ltd) were pre-mixed for several minutes in a Kneader. Then, 120 ml aqueous formic acid (containing 37 weight-% formic acid; based on formic acid having 98-100 weight-%, Bernd Kraft GmbH) were added under mixing and a dough-like homogeneous pink mass was formed.

The kneading mass was then shaped into 3.5 mm ropes. The ropes were dried at 90° C. for 16 h, subsequently calcined for 2 h at 400° C. and then split into particles having an inner diameter of 0.5-1 mm. Prior to catalytic testing the split was calcined. For calcination, the moldings were heated within 3 hours to a temperature of 700° C. and said temperature was held for 1 hour. Then the moldings were heated further to a temperature of 1200° C., and the temperature was held for 4 hours. The calcination was done in an annealing furnace.

### Example 9: Preparation of a Composite Oxide of Co, La, and Al

160 g aqueous AlOOH (Disperal; Sasol; containing 77.6 weight-% of Al calculated as Al₂O₃), 31.9 g cobalt(II)carbonate hydrate (containing 46 weight-% of Co; Umicore lot29371A0205), 186.3 g lanthanum(III)carbonate hydrate (containing 41 weight-% La; Mongolia Baotuo Steel Rare Earth Int. trade co. ltd) were pre-mixed for several minutes in a Kneader. Then, 140 ml aqueous formic acid (containing 59 weight-% formic acid; based on formic acid having 98-100 weight-%, Bernd Kraft GmbH) were added under mixing and a dough-like homogeneous pink mass was formed.

The kneading mass was then shaped into 3.5 mm ropes. The ropes were dried at 90° C. for 16 h, subsequently calcined for 2 h at 400° C. and then split into particles having an inner diameter of 0.5-1 mm. Prior to catalytic testing the split was calcined. For calcination, the moldings were heated within 3 hours to a temperature of 700° C. and said temperature was held for 1 hour. Then the moldings were heated further to a temperature of 1200° C., and the temperature was held for 4 hours. The calcination was done in an annealing furnace.

### Characterisation of Catalysts

As it can be seen in the elemental analysis displayed in Table 1, the La content is increased in the inventive examples, while Al and Co are both lowered, resulting in samples with an increased amount of the LaAlO₃ (Co doped) phase (see Table 2).

TABLE 1
Elemental analysis of the samples from the examples
(after the second calcination step).

| | | | | Co:Al | Co:La |
|---|---|---|---|---|---|
| | Al | Co | La | [weight | [weight |
| | [wt.-%] | [wt.-%] | [wt.-%] | ratio] | ratio] |
| Comp. Example 8 | 37 | 7.5 | 17.7 | 0.20 | 0.42 |
| Comp. Example 1 | 37 | 7.3 | 18 | 0.20 | 0.41 |
| Comp. Example 2 | 36 | 7.2 | 18.6 | 0.20 | 0.39 |
| Example 3 | 34 | 7.1 | 21.4 | 0.21 | 0.33 |
| Example 4 | 33 | 6.8 | 23.6 | 0.21 | 0.29 |
| Example 5 | 31 | 6.5 | 26.3 | 0.21 | 0.25 |
| Example 6 | 30 | 6.2 | 28.9 | 0.21 | 0.21 |
| Example 7 | 31 | 6.6 | 28.8 | 0.21 | 0.23 |
| Example 9 | 28.8 | 6.4 | 32 | 0.22 | 0.20 |

TABLE 2
XRD analysis of the samples from the examples (composition according to XRD
phases (wt.-%) in absolute numbers and including any amorphous phases).

| | | LaAl_{(Co)}O₃ | | | | |
|---|---|---|---|---|---|---|
| | | (Co-doped | | | | |
| | LaCoAl₁₁O₁₉ | LaAlO₃) | Corundum | La(OH)₃ | CoAl₂O₄ | Crystallinity |
| Comp. Ex. 8 | 78.9 | 8.9 | 0 | 0 | 12.3 | 91 |
| Comp. Ex. 1 | 80.8 | 5.7 | 4.8 | 0.0 | 3.8 | 95 |
| Comp. Ex. 2 | 90.2 | 5.3 | 1.2 | 0.6 | 2.7 | 91 |
| Example 3 | 78.7 | 12.6 | 1.1 | 0.5 | 7.1 | 92 |
| Example 4 | 73.6 | 13.8 | 0.9 | 0.5 | 2.8 | 92 |
| Example 5 | 67.9 | 19.7 | 0.0 | 0.5 | 3.0 | 91 |
| Example 6 | 62.6 | 23.8 | 0.0 | 0.7 | 3.0 | 90 |
| Example 7 | 66.4 | 27.9 | 0.5 | <0.5 | 5.2 | 93 |
| Example 9 | 61.9 | 33.5 | 0 | <0.5 | 4.5 | 93 |

From the results from TPR analysis performed on Comparative Example 1 and on Examples 4, 5, and 6 which are displayed in FIGS. 1 and 2, it is noticeable that by increasing the amount of the LaAlO₃ (Co doped) phase, lower temperature peaks are appearing in TPR, which have positive influence on activation behavior. These observations are confirmed by the results from TPR analysis displayed in FIG. 3, which was performed on Comparative Examples 2 and 8 as well as on Examples 7 and 9, the latter examples having increased amounts of Co-doped LaAlO₃ and displaying lower temperature peaks in TPR compared to the results obtained using the samples from Comparative Examples 2 and 8.

As may be taken from the results displayed in Table 3, the lattice parameter a of the LaAl_{(Co)}O₃-phase is decreasing with decreasing content of Co and increasing content of La in the composite. This would appear to correlate with the fact that due to the somewhat larger ionic radius of Co³⁺ compared to Al³⁺, the LaAl_{(Co)}O₃-phase will display lower values for the lattice parameter a when it contains less cobalt. Accordingly, the LaAl_{(Co)}O₃-phase of the inventive examples contains less cobalt than the LaAl_{(Co)}O₃-phase of the comparative examples.

TABLE 3
XRD analysis of the samples from the examples.

| | lattice parameter | | |
|---|---|---|---|
| | a of the LaAl_{(Co)}O₃- | wt.-% La in | wt.-% Co in |
| | phase [Å] | composite | composite |
| Comp. Ex 2 | 3.79588 | 18.6 | 7.2 |
| Comp. Ex. 8 | 3.795647 | 17.7 | 7.5 |
| Example 3 | 3.795211 | 21.4 | 7.1 |
| Example 5 | 3.79459 | 26.3 | 6.5 |
| Example 4 | 3.7944 | 23.6 | 6.8 |
| Example 7 | 3.7942548 | 28.8 | 6.6 |
| Example 6 | 3.79353 | 28.9 | 6.2 |
| Example 9 | 3.7932177 | 32 | 6.4 |

### Example 10: Catalyst Testing in the Reforming of Methane in the Presence of H₂O and CO₂

Catalytic tests were performed on the single reactor test unit on the samples from Comparative Examples 1 and 2 and Examples 3, 5, and 6. As gas feeds CO₂, CH₄, N₂ and Ar were provided and online controlled by MFCs. Water was added to the feed stream by an evaporator connected to a water reservoir. Analysis of the product gas composition is carried out by online-GC using Ar as internal standard. GC-analytic enables the quantification of H₂, CO, CO₂, CH₄ and C₂-components. Duration of the GC-method was set to 24 min.

For catalytic tests, typically 15 ml catalyst as split (0.5-1.0 mm) were tested. The sample was placed in the isothermal zone of the reactor using a ceramic fitting. Prior to the start of the experiment the back pressure was determined. All catalysts were tested at a pressure of 20 bar, wherein for the start-up phase (phase #1), a feed of 95% N₂ and 5% Ar were conducted over the catalyst at a GHSV of 8000 h⁻¹, wherein the reactor was heated to 900° C. at a ramp of 1.07 K/min (14 h) followed by a feed of 80% N₂, 5% Ar, and 15% H₂O which was conducted over the catalyst at 900° C. at a GHSV of 8000 h⁻ for 20 min. After the start-up phase, the respective catalyst samples were tested under the conditions displayed in Table 4 according to a test protocol including 5 further phases.

TABLE 1
Test protocol.

| Phase | TOS | Temp | GHSV | CH₄—In | CO₂—In | H₂O—In | Ar—In | N₂—In |
|---|---|---|---|---|---|---|---|---|
| [#] | [h] | [° C.] | [h − 1] | [Vol, %] | [Vol, %] | [Vol, %] | [Vol, %] | [Vol, %] |
| 2 | 6 | 900 | 8000 | 40 | 40 | 15 | 5 | 0 |
| 3 | 30 | 950 | 4000 | 40 | 40 | 15 | 5 | 0 |
| 4 | 12 | 950 | 8000 | 40 | 40 | 15 | 5 | 0 |
| 5 | 12 | 950 | 4000 | 40 | 40 | 15 | 5 | 0 |
| 6 | 12 | 950 | 3000 | 25.9 | 42.5 | 25.9 | 5 | 0 |

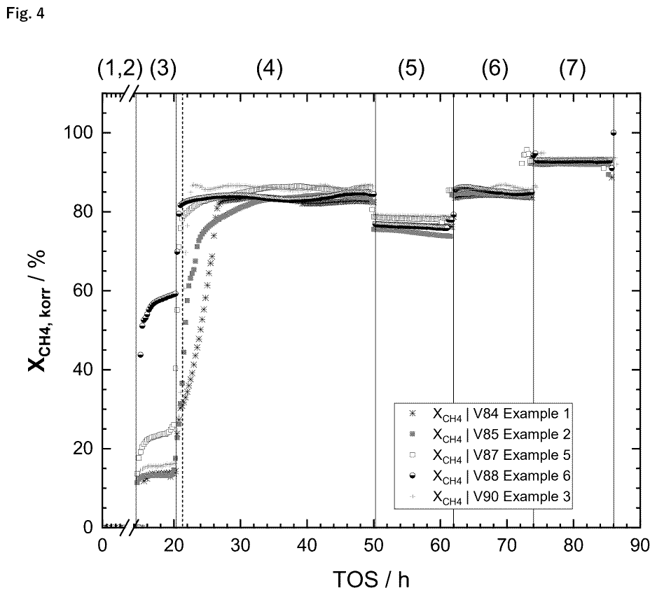

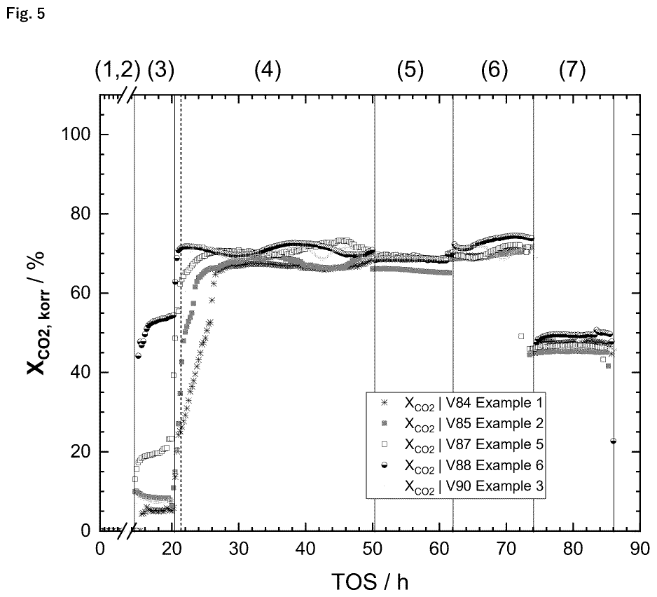

As may be taken from the results from the catalyst testing shown in FIGS. 4 and 5, and which show the conversion of methane (FIG. 4) and of CO₂ (FIG. 5) during the course of the testing, phase 3 is an activation phase in which the conversion increases with a certain rate as a function of time on stream. In phases 4 and 5 the performance of the catalyst is usually fully evolved, and conversion values may either decrease due to progressing deactivation of the catalyst or stay constant with increasing reaction time.

Based on the quantification of the product gas stream the CH₄ conversion [1], CO₂-conversion [2], H₂/CO-ratio as well as the product gas composition and C2-components fraction were calculated.

$${CH}_{4} - relative : X ( {CH}_{4} ) = 1 - ( {CH}_{4} \text{-out/} {CH}_{4} - in ) \qquad [ 1 ]$$

$${CH}_{2} - relative : X ( {CO}_{2} ) = 1 - ( {CO}_{2} \text{-out/} {CO}_{2} - in ) \qquad [ 2 ]$$

In addition, the relative conversions of CH₄ [3] and CO₂ [4] were calculated and represent the conversions related to the thermodynamic maximum conversions X_max (equilibrium composition). The equilibrium composition has been calculated taking the test conditions accordingly into account.

$${CH}_{4} - relative conversion : X\_rel ( {CH}_{4} ) = X ( {CH}_{4} ) / X\_max ( {CH}_{4} ) \qquad [ 3 ]$$

$${CH}_{2} - relative conversion : X\_rel ( {CO}_{2} ) = X ( {CO}_{2} ) / X\_max ( {CO}_{2} ) \qquad [ 4 ]$$

As noted above, experimental conversions are compared in FIGS. 4 and 5 for the catalyst examples. As it can be seen from the results, compared to Comparative Examples 1 and 2, Example 3 already displays clearly improved methane conversion rates during the activation stage (see FIG. 4), and the full conversion for the sample from Example 3 both with respect to methane and CO₂ conversion is not only reached well before the full conversion of the samples from Comparative Examples 1 and 2, but is furthermore substantially higher than the full conversion rates of the latter (see phase (4) in FIGS. 4 and 5, respectively).

Examples 5 and 6, on the other hand, reveal far easier activation which already clearly starts at 900° C., in particular with regard to the sample from Example 6 (see phase (3) in FIGS. 4 and 5, respectively).

Accordingly, it has quite surprisingly been found that the unique composition of the inventive samples lead to a clear surge in conversion activity at the activation stage, and afford clearly higher full conversion rates at a far earlier stage in the reaction compared to the samples from Comparative Examples 1 and 2.

### CITED LITERATURE

WO 2013/118078 A1
WO 2014/135642 A1
WO 2015/091310 A1
US 2016/0207031 A1
U.S. Pat. No. 9,566,571 B2
WO 2014/001423 A1
WO 2015/135968 A1
WO 2016/062853 A1
WO 2020/157202 A1

1.-15. (canceled)

16. A composite oxide comprising oxygen, lanthanum, aluminum, and cobalt, wherein a Co:La weight ratio of cobalt relative to lanthanum in the composite oxide, calculated as the elements, is in the range of from 0.06:1 to 0.34:1.

17. The composite oxide of claim 16, wherein the composite oxide contains from 1 to 15 wt.-% of cobalt, calculated as the element.

18. The composite oxide of claim 16, wherein the composite oxide contains from 5 to 50 wt.-% of lanthanum, calculated as the element.

19. The composite oxide of claim 16, wherein the composite oxide contains from 5 to 60 wt.-% of aluminum, calculated as the element.

20. The composite oxide of claim 16, wherein a Co:Al weight ratio of cobalt relative to aluminum in the composite oxide, calculated as the elements, is in the range of from 0.05:1 to 0.50:1.

21. The composite oxide of claim 16, wherein the composite oxide comprises an LaAl₁₋ₓCoₓO₃ phase, wherein 0<x<1.

22. The composite oxide of claim 21, wherein a lattice parameter a of the LaAl₁₋ₓCoₓO₃ phase is in the range of from 3.7920 to 3.7955 Å.

23. The composite oxide of claim 16, wherein the composite oxide comprises an LaCoAl₁₁O₁₉ phase.

24. The composite oxide of claim 16, wherein the composite oxide displays a crystallinity in the range of from 80 to 100%.

25. A method for the production of a composite oxide according to claim 16, the process comprising
(i) preparing a mixture of one or more sources of Al, one or more sources of Co, and one or more sources of La;
(ii) adding an acidic aqueous solution to the mixture prepared in (i);
(iii) homogenizing the mixture obtained in (ii);
(iv) optionally shaping the mixture obtained in (iii) for obtaining a shaped body;
(v) optionally drying the mixture obtained in (iii) or the shaped body obtained in (iv);
(vi) optionally pre-calcining the mixture obtained in (iii) or (v), or the shaped body obtained in (iv) or (v);
(vii) optionally milling the dried or pre-calcined mixture or shaped body obtained in (v) or (vi);
(viii) optionally tableting the ground product obtained in (vii); and
(ix) calcining the mixture obtained in (iii), (v), or (vi), or the shaped body obtained in (iv), (v), or (vi), or the ground product obtained in (vii), or the tableted product obtained in (viii).

26. A composite oxide obtained according to the method of claim 25.

27. A method for the production of a catalyst for the conversion of hydrocarbons to synthesis gas, the process comprising
(1) preparing a composite oxide according to claim 25; and
(2) reducing the composite oxide prepared in (1) for obtaining a catalyst.

28. The method of claim 27, wherein reduction in (2) is conducted in an atmosphere comprising one or more reducing agents, wherein the one or more reducing agents comprise one or more of methane, hydrogen, and carbon monoxide.

29. A catalyst for the conversion of hydrocarbons to synthesis gas as obtained according to the method of claim 27.

30. A process for the conversion of hydrocarbons to synthesis gas, the process comprising
(A) providing a composite oxide according to claim 16;
(B) preparing a gas stream comprising one or more hydrocarbons, and one or more of CO₂ and H₂O; and
(C) contacting the gas stream prepared in (B) with the composite oxide provided in (A) at a temperature in the range of from 700 to 1,200° C.
